(19) United States
(12) Patent Application Publication
(10) Pub. No.: US 2021/0268989 A1
(43) Pub. Date: Sep. 2, 2021

(54) SHOULDER SEAT BELT SEPARATOR DEVICE

(71) Applicant: William Critchlow, Sonoma, CA (US)

(72) Inventor: William Critchlow, Sonoma, CA (US)

(21) Appl. No.: 17/093,458

(22) Filed: Nov. 9, 2020

Related U.S. Application Data
(60) Provisional application No. 62/897,582, filed on Sep. 9, 2019.

(51) Int. Cl. B60R 22/30

(52) U.S. Cl. CPC B60R 22/30

(57) ABSTRACT

A shoulder belt separator device for a motor vehicle seat belt with a shoulder belt portion comprising a strap comprising a length of material with a first end and a second end, a first male fastener on the first end, and a first female fastener longitudinally spaced inwardly from the first male fastener on the first end of the strap such that when the first male fastener couples to the first female fastener a first loop is formed. The first loop is configured to wrap around the shoulder belt portion of the seat belt on the first end and the second end is clamped in a window such that the shoulder belt portion is pulled off a user.

### CROSS-REFERENCE TO RELATED APPLICATIONS

The present application is related to and claims the benefit under 35 U.S.C § 119(e) of the prior U.S. provisional application Ser. No. 62/897,582 filed Sep. 9, 2019 entitled “SHOULDER SEAT BELT SEPARATOR DEVICE”, the contents of which are incorporated herein by this reference in their entirety, and are not admitted to be prior art with respect to the present invention by the mention in this cross-reference section.

### BACKGROUND OF THE INVENTION

The present invention relates to the field of motor vehicle safety seat belts. In particular, the present invention relates to a device for relieving the tension of the shoulder belt portion of a safety seat belt on a user's upper torso.

Motor vehicle safety belts are typically comprised of a lap portion and an upper chest portion, also called the shoulder belt due to the position of the belt crossing in front of a driver's or passenger's torso and across their shoulder. Normally, the seat belts are installed by the automobile manufacturers and are constantly under tension while in use due to a spring-loaded mechanism. The use of the shoulder belt portion causes many drivers or passengers to feel constricted and uncomfortable.

The present invention solves the problem addressed above by providing a Shoulder Seat Belt Separator Device designed to pull the shoulder portion of a motor vehicle seat belt away from a driver or passenger such that the shoulder portion of the seat belt does not feel constricting or rub against the driver's or passenger's upper torso and/or neck area.

Any discussion of prior art throughout the specification should in no way be considered as an admission that such prior art is widely known or forms part of the common general knowledge in the field.

### BRIEF SUMMARY OF THE INVENTION

The present invention solves the problems noted above by providing a Shoulder Seat Belt Separator Device comprising a strap comprising a first end and a second end; at least one male fastener on each end of the length of material; and at least one female fastener longitudinally spaced apart from the male fastener on each end of the strap such that when the male fastener couples to the female fastener a loop is formed.

According to another object of the present invention, the loop is configured to loop around the shoulder portion of the seat belt on the first end.

According to another object of the present invention, the second end is configured to be clamped in a driver's side window in order to pull the shoulder portion of the seat belt off the shoulder of a user.

According to another object of the present invention, the second end is configured to wrap around an interior structure in order to pull the shoulder portion of the seat belt off the shoulder of a user.

According to another object of the present invention, the strap is comprised of a length of elastic material.

### BRIEF DESCRIPTION OF THE DRAWINGS

The present invention will now be described, by way of example only, with reference to the accompanying drawings in which:

FIG. 1 shows a front perspective view of using a Shoulder Seat Belt Separator Device according to the preferred embodiment of the present invention.

FIG. 2 shows a perspective view of the Shoulder Seat Belt Separator Device according to the preferred embodiment of the present invention.

FIG. 3 shows a perspective view of the Shoulder Seat Belt Separator Device according to an alternate embodiment of the present invention.

FIG. 4 shows a front perspective view of using the Shoulder Seat Belt Separator Device according to an alternate embodiment of the present invention.

### DETAILED DESCRIPTION OF THE INVENTION

The foregoing and other objectives, features, and advantages of the invention will be more readily understood upon consideration of the following description of the invention taken in conjunction with the accompanying drawings.

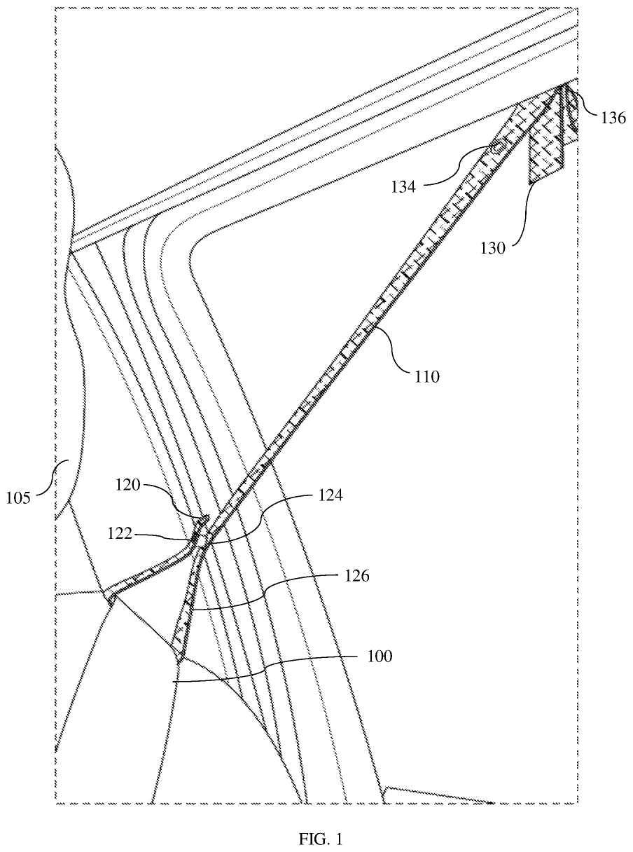

Now referring to the drawings, FIGS. 1-4 shows the present invention is preferably a shoulder seat belt separator device 110 for a motor vehicle seat belt with a lap portion and a shoulder portion 100. The shoulder seat belt separator device 110 is preferably designed and configured to pull the shoulder portion 100 of the seat belt away and off a user 105, whether the user is a driver or passenger of a motor vehicle.

As further shown in FIGS. 1-4, the shoulder belt separator device 110 preferably comprises a strap 115 comprising a length of material with a first end 120 and a second end 130. The first end 120 of the strap 115 preferably comprises a first male fastener 122 and a first female fastener 124 spaced longitudinally inwardly from the first male fastener 122. The first female fastener is spaced inwardly apart from the first male fastener on the first end of the strap such that when the male fastener couples to the female fastener a first loop 126 is formed.

The first male fastener 122 and first female fastener 124 are preferably a snap type fastener. Alternately, the first male fastener 122 and first female fastener 124 may be a tab and slot type fastener. Additionally, the fastener may be adjustable on the strap 115, such as a strap adjuster buckle where the first end of the strap is coupled to the strap adjuster buckle and the second end of the strap is fed through the locking bars and adjusted to the appropriate length.

As further shown in FIG. 1, the first loop 126 is preferably configured to loop around the shoulder portion 100 of a motor vehicle seat belt on the first end 120 of the strap 115. A user 105 would preferably wrap the first end 120 of the strap around the portion of the shoulder belt positioned on the user's shoulder. Then, the user 105 would preferably couple the first male fastener 122 to the first female fastener 124.

As further shown in FIG. 1, the first loop 126 encircles the shoulder portion of the seat belt such that when the second end 130 is clamped in between the side window and the top portion of the door frame, the shoulder portion 100 of the seat belt is lifted off the user's 105 shoulder. Ideally, the seat belt separator device 110 is positioned such that the shoulder portion of the seat belt is only lifted off the user's shoulder by approx. 1-2″.

As further shown in FIG. 1, the second end 130 of the strap 115 is preferably configured to be clamped within a motor vehicle's window. In this example, the window is lowered, the second end 130 of the strap is placed through the open window, and then the window is raised such that the second end 130 is clamped between the window and the vehicle frame.

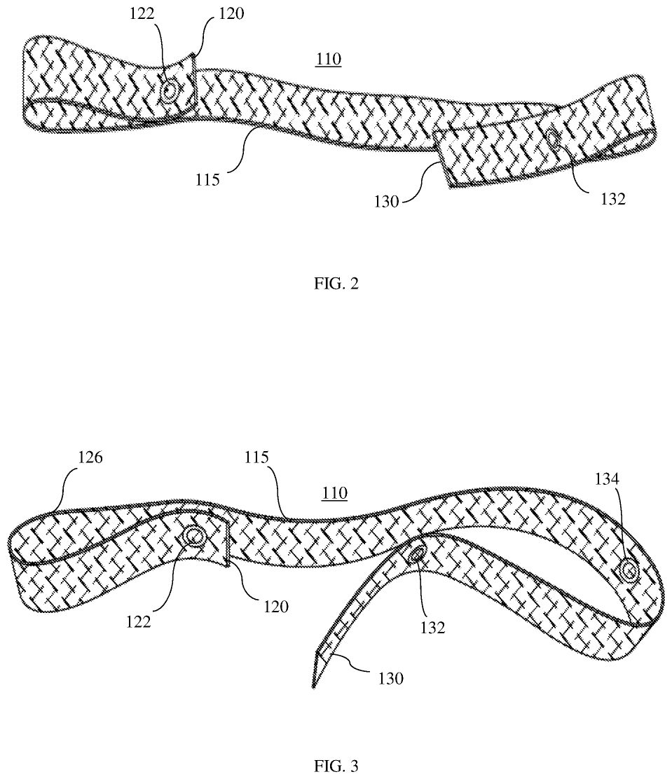

As further shown in FIGS. 2-4, the second end 130 of the strap 115 preferably comprises a second male fastener 132 and a second female fastener 134 spaced longitudinally inwardly from the second male fastener 132. When the second male fastener 132 is coupled to the second female fastener 134 on the second end of the strap a second loop 136 is formed. The second loop 136 is placed outside the motor vehicle's window such that the second loop 136 cannot slip between the closed motor vehicle's window and the motor vehicle door frame.

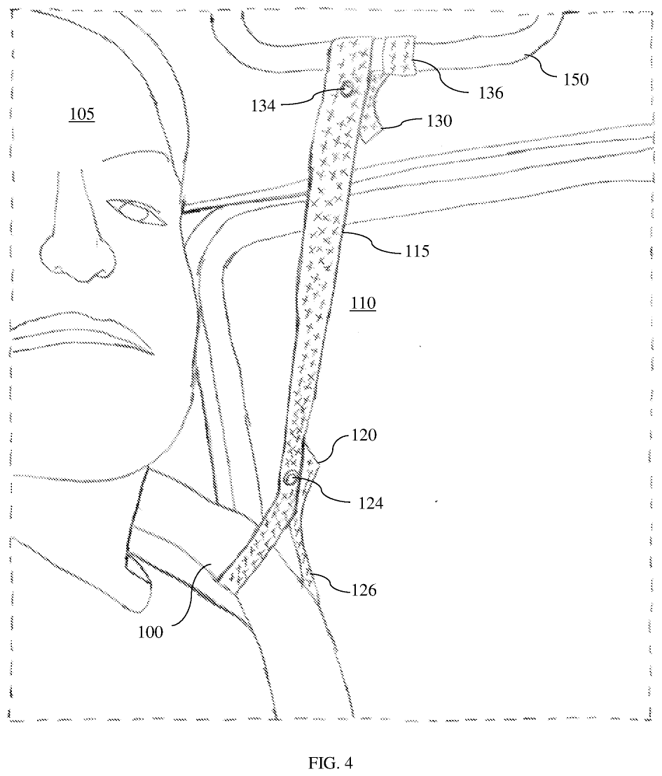

Alternately, as shown in FIG. 4, the second loop 130 is configured to wrap around an interior structure 150 located inside near a roof area. The second loop 130 is attached to an interior 150 structure of the motor vehicle, such as a grab handle or visor, by wrapping the second end 130 of the strap 115 around the interior structure 150 and fastening the second male fastener 132 on the second end 130 to the second female fastener 134 such that the shoulder portion of the seat belt is lifted off the user's 105 shoulder by approx. one to two inches.

The strap 115 is comprised of a length of material preferably comprised of an elastic or semi-elastic material. The length of material is preferably approximately 24 inches long and approximately 1 inch wide. The first and second male fasteners are preferably located approximately ¾ of an inch from the first and second ends of the length of material. The first and second female fasteners are located approximately 6 inches from the first and second male fasteners along the length of the strap 115.

Alternately preferably, the strap 115 is comprised of a non-elastic material. The strap 115 may be comprised of any material suitable for the purpose described herein. Alternately preferably, the strap 115 may be comprised of multiple sections of elastic and non-elastic materials stitched together, or otherwise attached together, to create one length of material.

The strap 115 may further comprise a layer of non-slip material on one or both sides of the length of material. The non-slip material prevents the seat belt portion from sliding within the first loop 120 and prevents the strap 115 from sliding between the window and door frame when clamped in place.

The male and female fasteners are preferably snap-type fasteners, where the male fastener is a button configured to tightly couple to the female fastener. Alternately preferably, the male and female fasteners could be a hook and loop type fastener. In another example, the male and female fasteners could be a tab and slot type fastener.

As shown in FIG. 5, a method for using a shoulder belt separator device, comprising the steps of looping a first end of a strap around a motor vehicle shoulder seat belt; fastening a first male fastener on the first end of the strap to a first female fastener spaced inwardly from the first male fastener such that a first loop is formed around the motor vehicle shoulder seat belt; attaching a second end of the strap to a portion of an adjacent door to pull the motor vehicle shoulder seat belt off a shoulder area of a user;

The step of attaching the second end of the strap comprises the steps of wrapping the second end of the strap around an interior structure on an upper inside surface of the motor vehicle; fastening a second male fastener on the second end of the strap to a second female fastener spaced inwardly from the second male fastener such that a second loop is formed around the grab handle.

The step of attaching the second end of the strap comprises the steps of opening a side window of a motor vehicle; extending the second end of the strap outside of the side window; and closing the side window to clamp the second end of the strap between the side window and a top portion of a motor vehicle side door.

The steps of creating a second loop by fastening a second male fastener on the second end to a second female fastener spaced inwardly from the second male fastener such that a second loop is formed; wherein the second loop is placed outside the open side window and the side window is closed such that the second loop prevents the strap from sliding through the side window and keeping the shoulder belt off the shoulder area of the user.

Although the present invention has been described by way of example, it should be appreciated that variations and modifications may be made without departing from the scope of the invention. Furthermore, where known equivalents exist to specific features, such equivalents are incorporated as if specifically referred to in this specification.

I claim:

1. A shoulder belt separator device for a motor vehicle seat belt with a shoulder belt portion comprising:
a strap comprising a length of material with a first end and a second end;
a first male fastener on the first end; and
a first female fastener longitudinally spaced inwardly from the first male fastener on the first end of the strap such that when the first male fastener couples to the first female fastener a first loop is formed;
wherein the first loop is configured to wrap around the shoulder portion of the seat belt on the first end; and
wherein the second end is clamped in a window such that the shoulder belt portion is pulled off a user.

2. The shoulder belt separator device of claim 1, wherein the strap is comprised of an elastic length of material.

3. The shoulder belt separator device of claim 1, wherein the first male fastener and the first female fastener is comprised of a snap type fastener.

4. The shoulder belt separator device of claim 1, further comprising:
a second male fastener on the second end of the strap; and
a second female fastener longitudinally spaced inwardly from the second male fastener on the second end of the strap such that when the second male fastener couples to the second female fastener a second loop is formed.

5. The shoulder belt separator device of claim 4, wherein the second loop is configured to wrap around an interior structure to pull the shoulder portion of the seat belt off the shoulder of the user.

6. The shoulder belt separator device of claim 4, wherein the second loop is placed outside a side window next to the user and the side window closed to clamp the strap between the side window and the door frame such that the second loop prevents the strap from sliding between the side window and the door frame.

7. The shoulder belt separator device of claim 5, wherein the second male fastener and second female fastener is comprised of a snap type fastener.

8. The shoulder belt separator device of claim 5, wherein the interior structure is a grab handle.

9. The shoulder belt separator device of claim 5, wherein the interior structure is a visor.

10. A shoulder belt separator device, comprising:
a seat belt in a motor vehicle comprising a lap belt portion and a shoulder belt portion
a strap comprising a length of material with a first end and a second end;
a first male fastener on the first end and a first female fastener longitudinally spaced inwardly from the first male fastener such that when the first male fastener couples to the first female fastener a first loop is formed; and
a second male fastener on the second end of the strap and a second female fastener longitudinally spaced inwardly from the second male fastener such that when the second male fastener couples to the second female fastener a second loop is formed;
wherein the first loop is configured to wrap around the shoulder belt portion of the seat belt; and
wherein the second loop is wrapped around an interior structure such that the shoulder belt separator device pulls the shoulder belt portion off of a user's shoulder.

11. The shoulder belt separator device of claim 10, wherein the strap is comprised of an elastic length of material.

12. The shoulder belt separator device of claim 10, wherein the first male fastener and the first female fastener is comprised of a snap type fastener.

13. The shoulder belt separator device of claim 10, wherein the interior structure is a grab handle.

14. The shoulder belt separator device of claim 10, wherein the interior structure is a visor.

15. A method for using a shoulder belt separator device, comprising the steps of:
looping a first end of a strap around a motor vehicle shoulder seat belt;
fastening a first male fastener on the first end of the strap to a first female fastener spaced inwardly from the first male fastener such that a first loop is formed around the motor vehicle shoulder seat belt;
attaching a second end of the strap to a portion of an adjacent door to pull the motor vehicle shoulder seat belt off a shoulder area of a user.

16. The method of claim 15, wherein the step of attaching the second end of the strap comprises the steps of:
wrapping the second end of the strap around an interior structure on an upper inside surface of the motor vehicle;
fastening a second male fastener on the second end of the strap to a second female fastener spaced inwardly from the second male fastener such that a second loop is formed around the interior structure.

17. The method of claim 15, wherein the step of attaching the second end of the strap comprises the steps of:
opening a side window of a motor vehicle;
extending the second end of the strap outside of the side window; and
closing the side window to clamp the second end of the strap between the side window and a top portion of a motor vehicle side door.

18. The method of claim 17, comprising the steps of:
creating a second loop by fastening a second male fastener on the second end to a second female fastener spaced inwardly from the second male fastener such that a second loop is formed; and
wherein the second loop is placed outside the open side window and the side window is closed such that the second loop prevents the strap from sliding through the side window and keeping the shoulder belt off the shoulder area of the user.
